(19) United States
(12) Patent Application Publication
(10) Pub. No.: US 2007/0101568 A1
(43) Pub. Date: May 10, 2007

(54) Method for improved fixture design

(76) Inventor: Michael J. Doom, Fraser, MI (US)

Correspondence Address: WARN, HOFFMANN, MILLER & LALONE, .P.C, PO BOX 70098, ROCHESTER HILLS, MI, 48307, US

(21) Appl. No.: 11/593,180

(22) Filed: Nov. 3, 2006

Related U.S. Application Data
(60) Provisional application No. 60/733,723, filed on Nov. 4, 2005.

(51) Int. Cl. B23Q 7/00

(52) U.S. Cl. 29/559; 29/428

(57) ABSTRACT

A method for creating fixtures used in the build of prototype parts, including a base plate having various holes and notches with various details mounted onto the base plate, and wherein the various details are used to support a prototype part, and the prototype part is created by using the fixture. The method comprises the steps of first using a milling or other process for producing a base plate having the predetermined precisely located holes and notches. An electrical discharge machining process is used to create the various details. The details are then assembled onto the base plate to create a predetermined fixture. The fixture is then used to create the prototype part.

### CROSS-REFERENCE TO RELATED APPLICATIONS

This application claims the benefit of U.S. Provisional Application No. 60/733,723, filed Nov. 4, 2005.

### FIELD OF THE INVENTION

The present invention is related to building fixtures used in the creation of prototype components to aid in product development.

### BACKGROUND OF THE INVENTION

It is common practice in almost all areas of manufacturing to develop prototype components which are tested to ensure the components are ready for production and can be released into the marketplace. Larger manufacturing companies, particularly in the automotive industry, often work with suppliers in developing prototype components which will eventually be used in production. The steps in the product development process typically involve the design of the component, the creation of prototype parts, and the testing of the prototype parts to determine what changes, if any, in design are necessary. Because this process involves making the prototype parts for the first time, this process often involves the creation of tooling, or fixtures. The fixtures are then used to align components of the prototype parts for final assembly or post assembly processes, such as tolerance inspections.

One type of part that is commonly developed using this type of process is a door panel. The initial design of the door panel can be done using Computer Aided Design (CAD) software, ProE, or some other type of computer software having the capability to design the part. Fixtures are then created to build the prototype of the door panel, and the door panel can then be tested to determine if it will be suitable for production.

However, also common to the manufacturing industry is the problem that creating fixtures to build prototype parts is time consuming. Current methods of fixture construction are labor intensive and require a significant amount of man-power in the form of skilled workers. Because of this, turnaround times are high. Also, the results achieved by the current fixture design process are often of poor quality, and do not always meet the increasingly more demanding dimensional requirements. As products become more sophisticated, the tolerances allowed for the various dimensions of the components become more restrictive, and current methods of fixture design often do not meet these requirements.

Accordingly, there exists a need for an improved method of fixture design which reduces the time involved in creating the fixture itself, while at the same time improving the quality of the prototype part made from the fixture.

### SUMMARY OF THE INVENTION

The present invention is a method for creating fixtures used in the build of prototype parts, including a base plate having various holes and notches with various details mounted onto the base plate, and wherein the various details are used to support a prototype part, and the prototype part is created by using the fixture. The method comprises the steps of first using a milling or other process for producing a base plate having the predetermined precisely located holes and notches. An electrical discharge machining process is used to create the various details. The details are then assembled onto the base plate to create a predetermined fixture. The fixture is then used to create the prototype part.

The notches on the base plate are T-shaped notches, and the details have protrusions which are received by the notches of the base plate for holding the details in place. The details also have recesses and projections which allow the details to interconnect with one another, simplifying the assembly of the fixture. The details in the fixture are held together by fasteners, which allow the details to be easily and quickly assembled and disassembled.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an isometric view of one embodiment of a fixture made according to the method of the present invention supporting a prototype part;

FIG. 2 is an isometric view of one embodiment of a fixture made according to the method of the present invention;

FIG. 3 is a side view of various details made according to the method of the present invention;

FIG. 4 is a side view of more various details made according to the method of the present invention;

FIG. 5 is a side view of even more various details made according to the method of the present invention; and

FIG. 6 is a isometric view of a base plate having various holes and notches made according to the method of the present invention.

### DETAILED DESCRIPTION OF THE PREFERRED EMBODIMENTS

The following description of the preferred embodiment(s) is merely exemplary in nature and is in no way intended to limit the invention, its application, or uses.

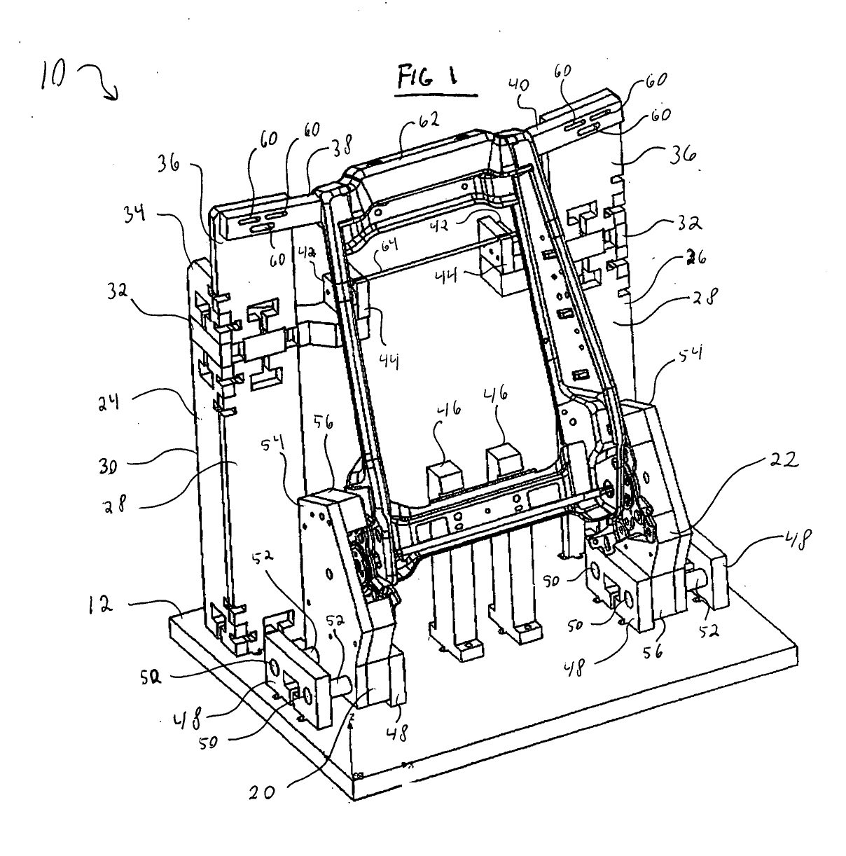

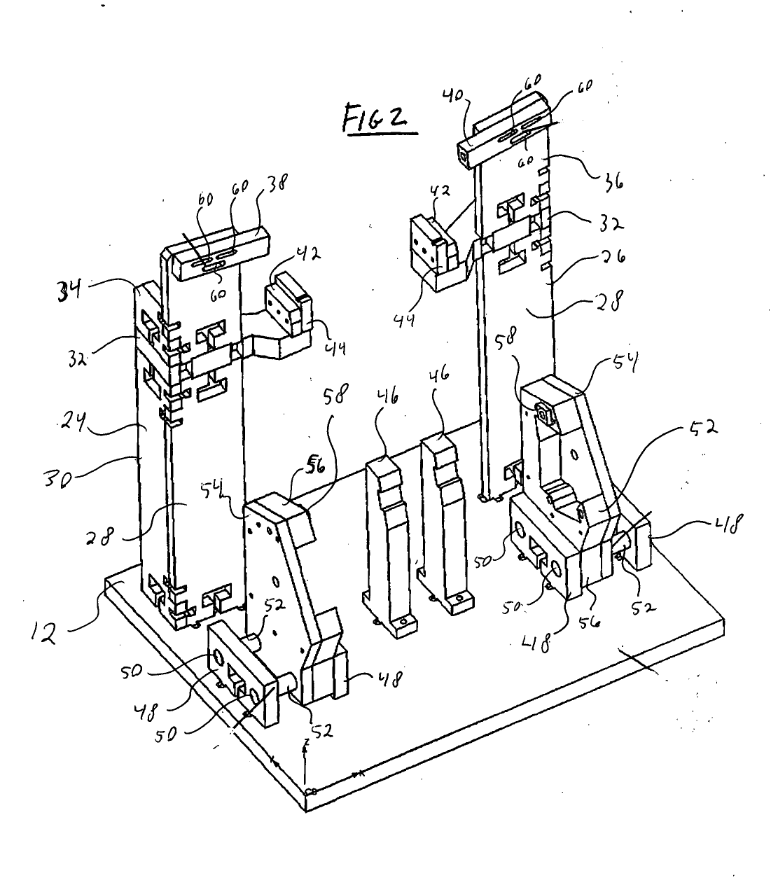

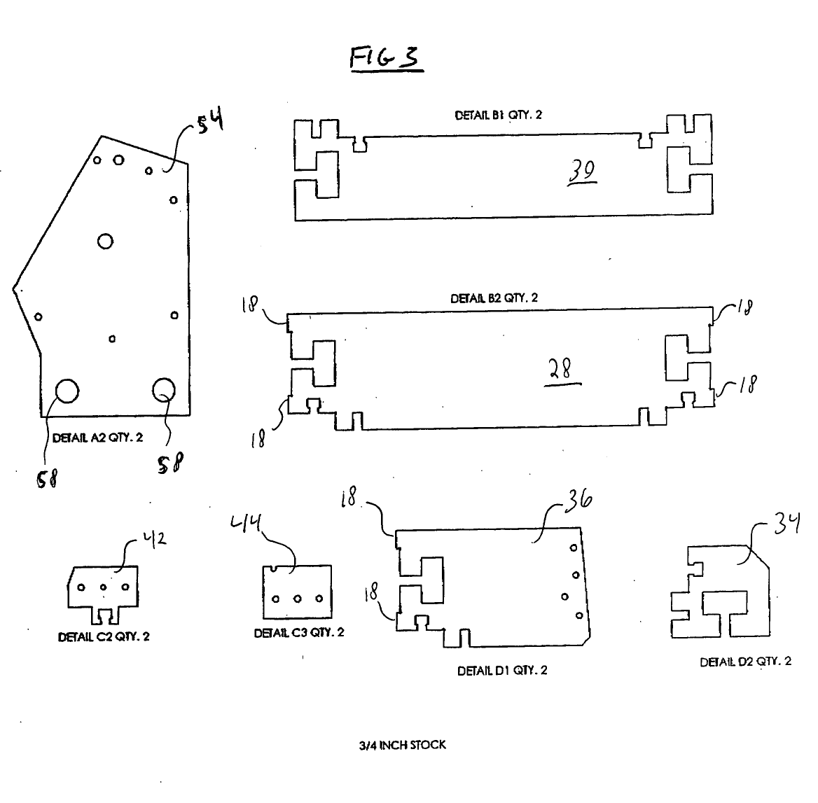

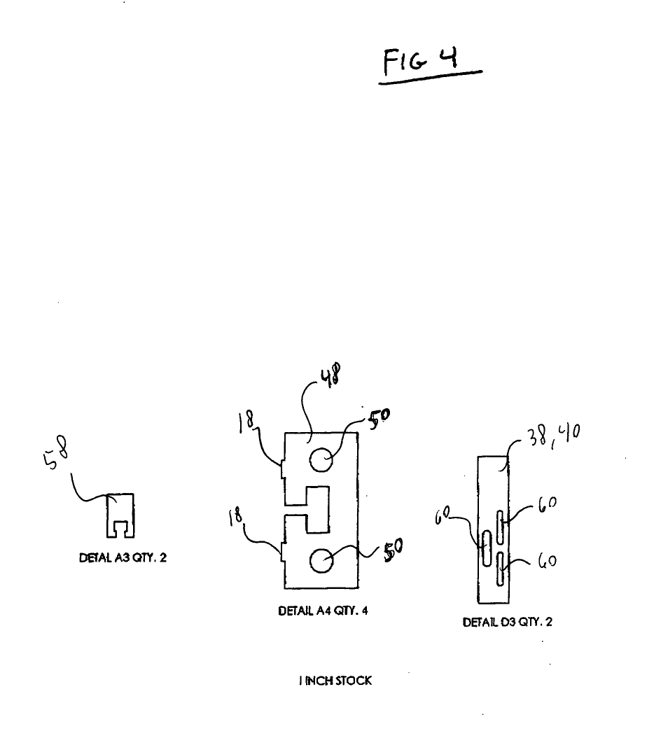

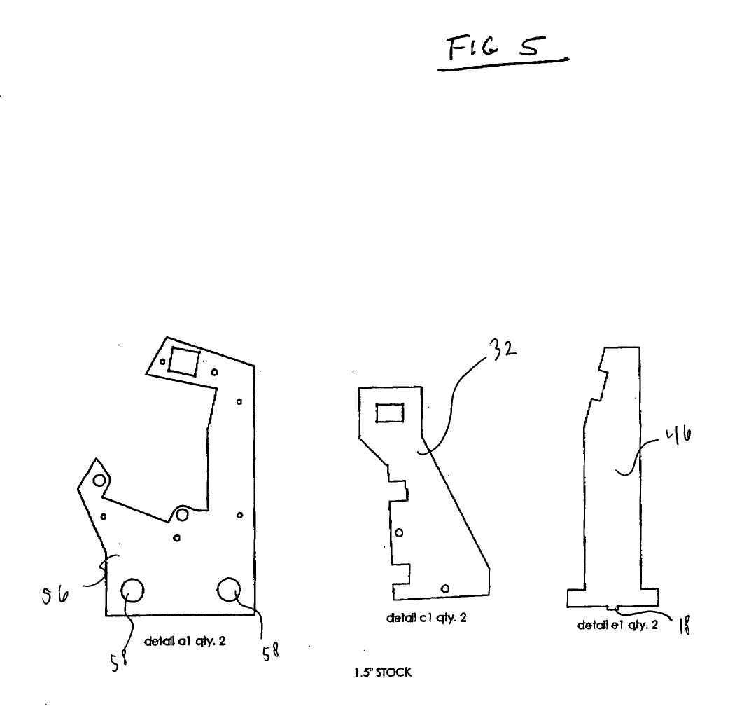

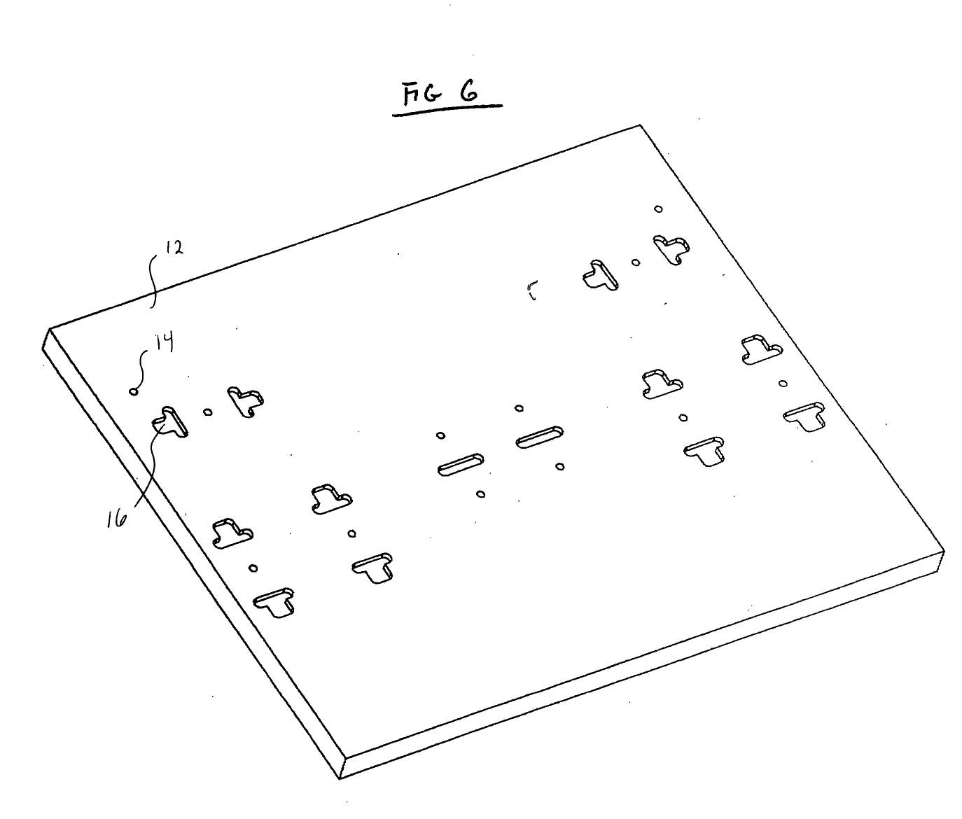

Referring to FIGS. 1-6, a fixture for the production of prototype parts created according to the method of the present invention is shown at 10. The fixture 10 has a base 12 which can be equipped with various mounting orifices, such as holes 14 and notches 16, used for receiving protrusions 18 on the various fixture components or details. The notches 16 are preferably in the form of a “T-shape,” which allows the notches to provide a higher level of precision with regard to holding the details in place. Other slot forms such as straight, I shaped, H shaped, or others which allow the respective protrusion to engage the slot in a precision positioning of the detail can be utilized. The protrusion 18 can also be used on the details to be connected with one another, as well as the base 12. In the embodiment shown, a first slide detail 20 and a second slide detail 22 are mounted to the base 12. A first elongated detail 24 and a second elongated detail 26 are also mounted on the base 12 in proximity to the first slide detail 20 and the second slide detail 22. Both the first elongated detail 24 and the second elongated detail 26 are made of two flat elongated details 28 and 30.

Mounted on first elongated detail 24 and second elongated detail 26 is an angled detail 32. Mounted on each angled detail 32 are corner details 34 and raised details 36. Mounted on the raised details 36 are third slide detail 38 and fourth slide detail 40. Also mounted on each angled detail 32 is an edge detail 42 and a notch detail 44. The base 12 also features two inner support details 46.

Mounted into the base 12 are outer support details 48 which feature bores 50 for receiving shafts 52. Also mounted onto shafts 52 are solid angled support detail 54 and hollow angled support detail 56, which also have bores 50 for receiving the shafts 52. The solid angled support detail 54 and hollow angled support detail 56 are connected together and move as a solid component on the shafts 52. Connected to hollow angled support detail 56 is a small detail 58.

The third slide detail 38 and the second slide detail 40 each have elongated slots 60 which are used to receive a fastener to connect the third slide detail 38 and fourth slide detail 40 to their respective raised details 36.

The embodiment shown is used to hold the frame 62 for a seat in place so the various parts of the frame 62 can be welded together in a meticulous fashion. For example, the frame 62 is supported by the first slide detail 20, second slide detail 22, third slide detail 38, fourth slide detail 40, and inner support details 46. The notched details 44 are used to hold rod 64 in place, while the frame 62 also rests against the edge details 42. The rod 64 can then be welded to the frame 62, allowing for a higher level of precision over previously used methods.

The method of the present invention is not limited to the construction of the fixture 10 described above. All of the details described in the embodiment above are made from aluminum “flat stock.” In the present invention it is preferred that aluminum flat stock having 0.001″ maximum thickness variation in the surface is used. This type of material can be made using the steps of the present invention into virtually unlimited shapes and sizes to create details that can accommodate the manufacture of virtually any prototype part that requires welding, cutting, fixturing part inspection or assembly.

The base plate 12 is preferably created by using a CNC machine, the CNC machine also can place into the base plate 12 the various holes 14 and notches 16 which are used to support the various details. Using a CNC machine to create the base plate 12 reduces the time needed to create the base plate 12, and reduces the amount of error in the dimension of the holes 14 and notches 16. The various details are created by an Electrical Discharge Machining (EDM) process; this process is significantly faster than creating the details from manual or CNC milling, and also allows for much improved accuracy in the various details. Because the details can be created faster, any particular prototype that needs to be built can also be created faster, and the prototype will meet the stringent dimensional tolerance requirements.

Another advantage of the present invention is that the details are shaped having various recesses and projections which are used to simplify the assembly of the fixture 12 as a whole. The details used in the fixture 10 can be held in place with separate fasteners. For example, the separate fasters can be a threaded nut and bolt; the advantage of the present invention is that none of the details in the fixture 10 will require drilling and tapping. The fasteners are a completely separate component from any of the details in the fixture 10.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for creating fixtures used in the build of prototype parts, comprising:
providing a base plate having at least one mounting orifice of precise tolerances and in predetermined locations;
providing at least one detail produced with an electronic discharge machining process having a portion that is securable in said mounting orifice at a predetermined location in said base plate; and
assembling said at least one detail onto said base plate to create a fixture for using said fixture for mounting a part.

2. The method of claim 1 further comprising the steps of providing at least one mounting orifice on said base plate to be comprised of T-shaped notches.

3. The method of claim 1 further comprising the steps of:
holding said details in place by providing said details with protrusions which are received by said at least one mounting orifice of said base plate.

4. The method of claim 1 further comprising the steps of:
providing recesses and projections in said details;
connecting said details with one another by using said recesses and said projections; and
providing indexed assembly of said fixture with said details.

5. The method of claim 4 further comprising the steps of providing fasteners for holding said details together.

6. A fixture for building prototype parts, comprising:
a base plate having a series of mounting orifices;
a series of details having at least one protrusion which are securable to said series of mounting orifices on said base plate; and
wherein said series of details are assembled onto said base plate to form a fixture for building prototype parts.

7. The fixture assembly of claim 6, wherein said series of mounting orifices are T-shaped notches used for receiving protrusions on said series of details.

8. The fixture assembly of claim 6, wherein said series of details are used for positioning a part for assembly and welding.

9. The fixture assembly of claim 8, wherein said part is connected to said series of details by the use of at least one fastener.

10. The fixture assembly of claim 6, wherein said series of details are further comprised of aluminum flat stock having a variation in thickness of less than 0.001″.

11. The fixture assembly of claim 6, wherein said base plate is comprised of a harden steel.

12. A fixture assembly used for building prototype parts in a manufacturing process comprising:
a base plate having at least one mounting orifice used for receiving a series of details;
a series of fasteners used for connecting said series of details together; and
wherein said series of details are used for supporting prototype part components, allowing said prototype part components to be assembled.

13. The fixture assembly of claim 12, wherein said series of details are comprised of aluminum flat stock, having a variation in thickness of less than 0.001″.

14. The fixture assembly of claim 12, wherein said series of details are made from an electrical discharge machining process.
